(19) United States
(12) Patent Application Publication
(10) Pub. No.: US 2010/0044544 A1
(43) Pub. Date: Feb. 25, 2010

(54) Wireless LAN Survey Carts

(75) Inventor: Pat R. Falcone, Houston, TX (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/195,999

(22) Filed: Aug. 21, 2008

(51) Int. Cl. F16M 13/00

(52) U.S. Cl. 248/512; 248/519

(57) ABSTRACT

An apparatus according to one embodiment of the invention includes at least one mast connected to a platform, and a boom connected to the mast. In at least one alternative embodiment, the mast is telescopic. The apparatus also has a detector connected to the boom, and a power supply connected to the detector. In at least one embodiment, the detector is a wireless LAN detector. The mast has a first segment and one or more additional segments, wherein the mast adjusts a height of the detector relative to the platform. Further, the apparatus has a dropped ceiling tee grid attached to the boom and the detector, and one or more casters connected to the platform. The casters facilitate continuous movement of the detector to reduce set up time of the detector in multiple locations.

### FIELD OF THE INVENTION

The present invention is in the field of wireless local area network (LAN) survey carts.

### BACKGROUND OF THE INVENTION

Large areas of commercial and residential properties often need to be surveyed for wireless LAN signals. In order to perform these surveys, test access points need to be set up at regular intervals in order to measure signal strength in the service area. The normal mode for these surveys is for a technician to climb a ladder, attach an access point to a ceiling grid, then begin performing the survey. This requires a technician to use a mechanics style wheel mounted tool box to store equipment and a ladder to connect access points to a ceiling grid. When dry wall ceilings are encountered, a tripod is used so that the access point can be placed as close to the ceiling and the survey performed. The set-up and break-down time for these operations takes a large amount of time.

### SUMMARY OF THE INVENTION

An apparatus according to one embodiment of the invention includes at least one mast connected to a platform, and a boom connected to the mast. In at least one alternative embodiment, the mast is telescopic. The apparatus also has a detector connected to the boom, and a power supply connected to the detector. In at least one embodiment, the detector is a wireless LAN detector. The mast has a first segment and one or more additional segments, wherein the mast adjusts a height of the detector relative to the platform. Further, the apparatus has a dropped ceiling tee grid attached to the boom and the detector, and one or more casters connected to the platform. The casters facilitate continuous movement of the detector to reduce set up time of the detector in multiple locations.

It is contemplated in an alternative embodiment that the apparatus lacks a boom and/or power source. In yet another alternative embodiment, the apparatus has at least one additional mast connected to the platform, at least one additional boom connected to the additional mast, and at least one additional detector connected to the additional boom. In such an embodiment, the mast, the additional mast, the boom, and/or the additional boom are telescopic.

### BRIEF DESCRIPTION OF THE DRAWINGS

The present invention is described with reference to the accompanying drawings. In the drawings, like reference numbers indicate identical or functionally similar elements.

FIG. 1 illustrates a wireless LAN survey cart according to one embodiment of the invention;

FIG. 2 illustrates an enlargement of a portion of the wireless LAN survey cart illustrated in FIG. 1;

FIG. 3 illustrates a wireless LAN survey cart according to another embodiment of the invention;

FIG. 4 illustrates a wireless LAN survey cart according to yet another embodiment of the invention; and

FIG. 5 is a flow diagram illustrating a method of manufacturing a wireless LAN survey cart according to one embodiment of the invention.

### DETAILED DESCRIPTION OF THE DRAWINGS

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention allows for the continuous movement of a wireless survey technician, thereby eliminating all set-up time for individual measurement points and reducing the need for a large tool box and ladder to perform active wireless surveys. The wireless survey carts allow the technician to perform continuous active wireless surveys to reduce equipment set-up time to near zero. This can allow each survey team to survey approximately 50,000 square feet of space per day, reducing the amount of time to perform this work by about half.

At least one embodiment of the invention provides a telescopic boom mounted on a platform 110 with wheels 112. The platform 110 is used as a base for a vertical telescopic support 120. The vertical support 120 has a lateral boom 130 to allow for the attachment of the test access point 140. The vertical support 120 and the lateral boom 130 together are an example of a telescopic boom.

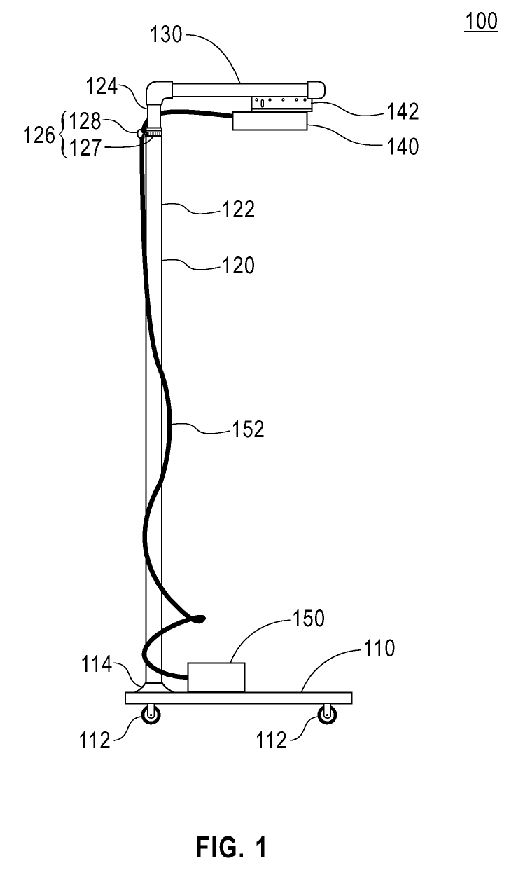

More specifically, an embodiment of the invention is illustrated in FIG. 1 as including a wireless LAN survey cart 100 generally includes a platform 110, a mast 120 extending upwards from the platform 110, and a boom 130 connected to a top portion of the mast 120. The survey cart 100 further includes a detector 140 connected to the boom 130 and a power source 150 connected to the detector 140 via a cable 152. Although the detector 140, the power source 150, and the cable 152 in an alternative embodiment are omitted. The power source 150 is remote (i.e., a standalone power source that does not require a standard electrical wall outlet, such as a battery or solar panel); however, in alternative embodiments it is contemplated that the detector 140 could include a power cord adapted to plug into an electrical wall socket. This arrangement places the detector 140 on a mobile apparatus that is capable of positioning the detector 140 in areas that may be difficult to access without a ladder, extension pole, or similar type of tool. Accordingly, the survey cart 100 facilitates the performance of a continuous and active wireless survey, thereby reducing equipment set-up time.

The platform 110 has one or more casters (e.g., wheels, roller balls) 112 removably or permanently attached thereto to facilitate movement of the cart 100 on a surface. In at least one embodiment, the casters 112 are formed from rubber, although it is contemplated in alternative embodiments that the casters 112 are formed from a variety of materials, including for example, metal, plastic, and/or other composites. Moreover, in at least one embodiment, the outer surface of the platform 110 has an epoxy finish and includes a flanged screw connection 114. As more fully described below, the flanged screw connection 114 is utilized to attach the mast 120 to the platform 110. Although, for example, FIG. 1 illustrates the platform 110 as rectangular, the platform 110 may have any shape and any size that will provide stability for the survey cart 100.

Furthermore, the survey cart 100 includes at least one mast 120 that is removably or permanently attached to the platform 110. In at least one embodiment, the mast 120 includes a threaded engagement (not shown) on a lower end thereof for attaching the mast 120 to the flanged screw connection 114 of the platform 110. In an alternative embodiment, the engagement components are reversed. In alternative embodiments, it is contemplated that other means may be utilized for attaching the mast 120 to the platform 110, such as, for exemplary purposes only, bolts, adhesive, and welding. As illustrated in FIG. 1, the mast 120 is attached towards an outer edge of the platform 110. However, it is contemplated in other embodiments that the mast 120 is situated in other positions on the platform 100 (e.g., directly centered).

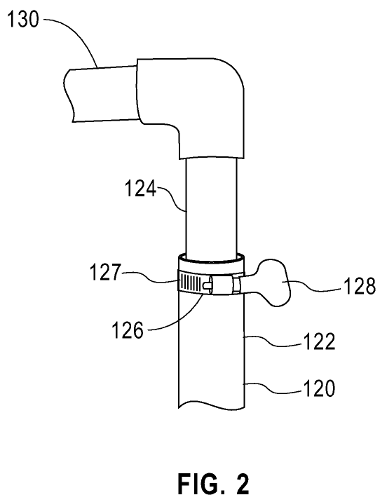

The mast 120, in at least one embodiment, is telescopic, i.e., includes a means for selectively adjusting the overall length/height of the mast 120. In one embodiment, as illustrated in FIGS. 1 and 2, the mast 120 includes a lower segment 122 and an upper segment 124 (also referred to herein as the first segment and the additional segment, respectively). In at least one embodiment, the lower segment 122 and the upper segment 124 are hollow cylinders that each have a size such that the upper segment 124 may be inserted into the lower segment 122. The lower segment 122 is attached to the platform 110; and, the upper segment 124 is slidably engaged within the lower segment 122, wherein the upper segment 124 is held in place via a clamp 126. Such an arrangement allows the upper segment 124 to extend upwards and away from the platform 110. The overall length of the mast 120 may be adjusted by extending the upper segment 124 out of the lower segment 122 and tightening the clamp 126. In alternative embodiments, the mast 120 includes more than two segments.

In at least one embodiment, as illustrated in FIG. 2, the clamp 126 includes a ring 127 that fits securely around the lower segment 122 of the mast 120. The diameter of the ring 127 can be modified by tightening (decreasing the diameter) or loosening (increasing the diameter) a screw 128. Thus, tightening of the screw 128 while the ring 127 is positioned around the lower segment 122 holds the upper segment 124 in place via friction. It is contemplated in alternative embodiments that one or more other means for adjusting the length of the mast 120 are utilized, such as, for example, threaded screw engagement, hole and peg locking mechanism, and removable extensions. Accordingly, the telescopic mast 120 allows the survey cart 100 to position the detector 140 in areas that are high off of the ground and would otherwise be difficult to access without the use of a ladder, extension pole, or similar type of tool.

In at least one embodiment, both the mast 120 and the boom 130 include hollow cylinders formed from polyvinyl chloride (PVC). However, it is contemplated in alternative embodiments that other shapes, sizes and materials are utilized, such as, for exemplary purposes only, metal, wood, plastic, and/or other composites. In one embodiment, as illustrated in FIGS. 1 and 2, the boom 130 is attached to the mast 120 via an elbow joint 132. Specifically, the elbow joint 132 has a first aperture for receiving a top end of the mast 120 and a second aperture for receiving one end of the boom 130, wherein the mast 120 and boom 130 are held in place within the elbow joint 132 via friction. It is contemplated in alternative embodiments that other means for attaching the boom 130 to the mast 120 may be utilized, such as, for exemplary purposes only, clamps, screws, bolts, and adhesive. In another alternative embodiment, the mast 120 (or the top segment of the mast) and boom 130 comprise a single unitary structure. In yet another alternative embodiment, the boom 130 is telescopic. In a further embodiment, the angle between the boom 130 and the mast 120 is a range of 0 to 180 degrees, and more particularly 90 to 180 degrees including the end points.

As illustrated in FIG. 1, the boom 130 extends horizontally from the mast 120, wherein the boom 130 positions the detector 140 above the platform 110. In at least one embodiment, the detector 140 is a wireless LAN detector adapted to measure the strength of signals emitted to and from wireless electronic devices. It is contemplated in alternative embodiments, however, that the survey cart 100 includes any type of detector, such as, for exemplary purposes only, detectors for measuring, other electronic signals, light, and/or sound.

In one embodiment, as illustrated in FIGS. 1 and 2, the detector 140 is connected to the boom 130 via a dropped ceiling tee grid 142. The dropped ceiling tee grid 142 is a standard tool that is used in the construction industry to install suspended ceiling tiles. Typically, the dropped ceiling tee grid 142 is universally adapted to clip on to wireless LAN detectors. In other words, the dropped ceiling tee grid 142 has a means for attaching to all or most wireless LAN detectors that is standard in the construction industry. Customized fasteners or adapters are not needed to attach a wireless LAN detector to the dropped ceiling tee grid 142. In at least one embodiment, the boom 130 has a slot 134 (not shown) laterally positioned thereon for receiving and holding a portion of the dropped ceiling tee grid 142. It is contemplated, however, in alternative embodiments that other means for attaching the detector 140 to the boom 130 may be utilized, such as, for exemplary purposes only, clamps, clips, ties, rings, screws, and bolts. In at least one alternative embodiment, the boom 130 is omitted, wherein the detector 140 is attached to the top of the mast 120 or a platform attached to the top of the mast.

In at least one embodiment, the power source 150 is a rechargeable battery attached to the platform 110 via brackets 154. It is contemplated, in alternative embodiments, that other sources capable of supplying power to the detector 140 are secured to the platform 110 via other means, such as, for example, clamps, clips, ties, hook and loop fasteners, screws, and bolts. In other alternative embodiments, more than one power source 150 is attached to the mast 120 and/or the boom 130. In yet another alternative embodiment, the detector 140 includes its own internal power source.

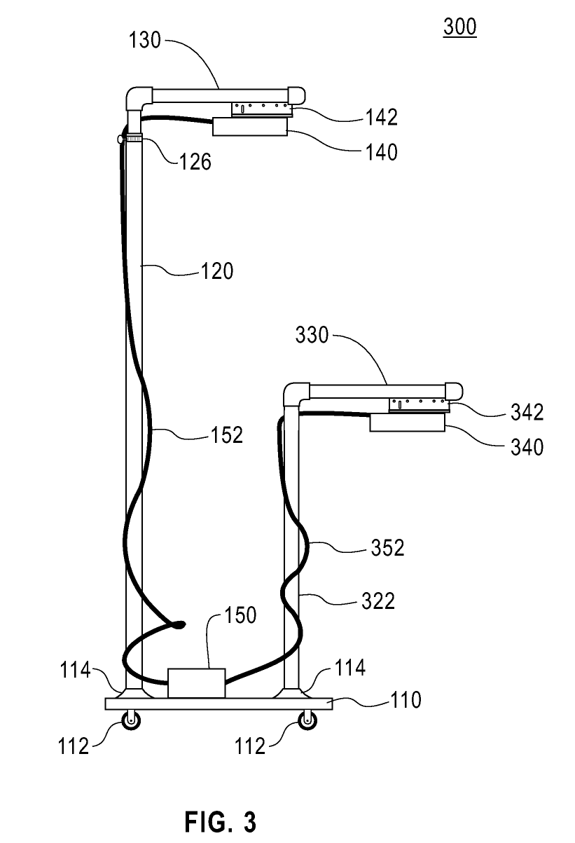

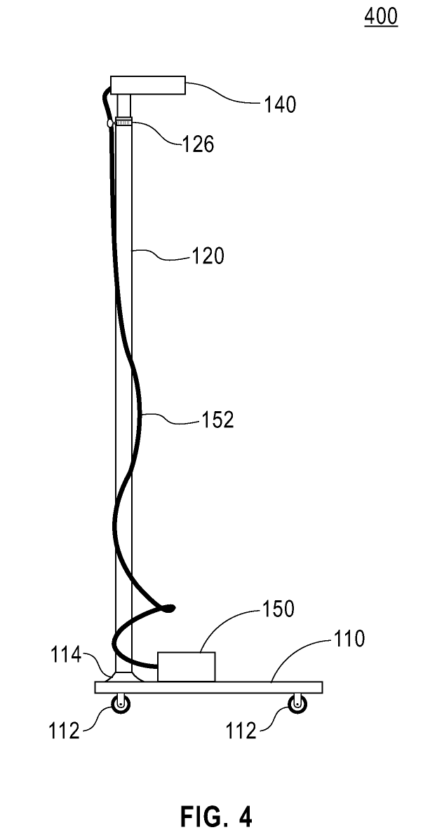

FIG. 3 illustrates a wireless LAN survey cart 300 according to another embodiment of the invention, wherein the survey cart 300 has a first mast 120 and at least one additional mast 322. In at least one embodiment, either or both masts are telescopic. A boom 330 is connected to a top portion of the mast 322. A dropped ceiling tee grid 342 is connected to the boom 330; and, a detector 340 is connected to the dropped ceiling tee grid 342. The detector 340 is also connected to the power source 150 via a cable 352, although in another embodiment, the detector 340 is connected to an additional power source (not shown). Thus, the survey cart 300 includes multiple detectors that allow operators to perform surveys at different heights without having to adjust the height of the masts. Moreover, the survey cart 300 allows operators to perform surveys at different heights simultaneously. In at least one embodiment (not shown), a survey cart lacks the additional detector 340, wherein both the first mast 320 and the additional mast 322 are utilized to support a single detector 340. FIG. 4 illustrates a wireless LAN survey cart 400 according to yet another embodiment of the invention, wherein the survey cart 400 lacks a boom 130. Thus, the detector 140 of the survey cart 400 is attached to the top of the mast 120.

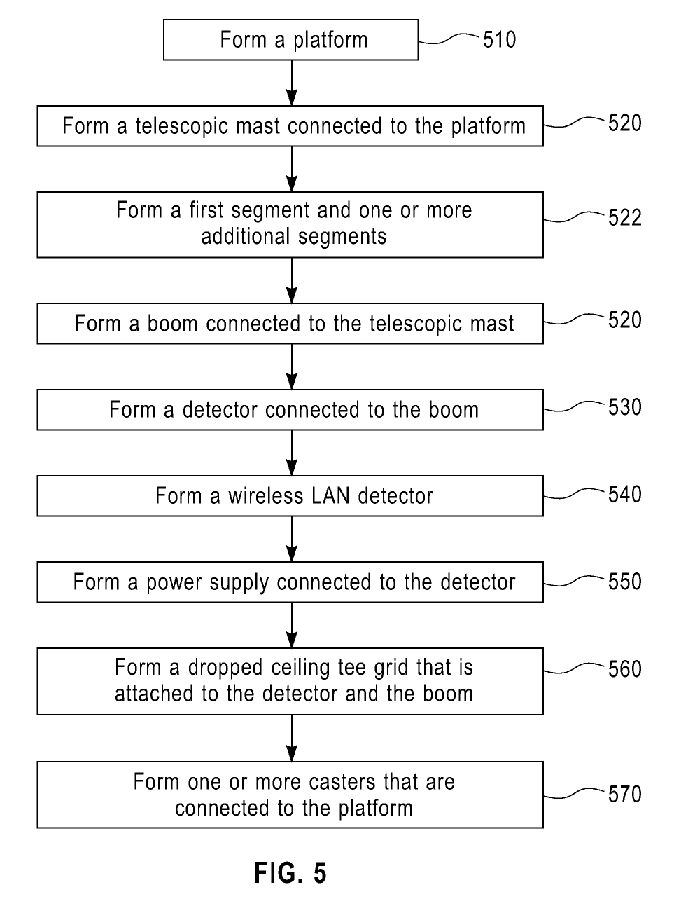

FIG. 5 is a flow diagram illustrating a method of manufacturing a wireless LAN survey cart according to one embodiment of the invention. The method forms a platform (510) and at least one telescopic mast connected to the platform (520). When forming the telescopic mast, a first segment and one or more additional segments are formed (522). The telescopic mast adjusts a height of the detector relative to the platform. Moreover, the method forms a boom connected to the telescopic mast (530) and a detector connected to the boom (540). In at least one embodiment, the forming of the detector forms a wireless LAN detector (542).

The method also forms a power supply connected to the detector (550) and a dropped ceiling tee grid that is attached to the detector and the boom (560). In addition, one or more casters are formed that are connected to the platform (570). The casters facilitate continuous movement of the detector to reduce set up time of the detector in multiple locations.

Accordingly, the present invention provides a mobile apparatus that is capable of positioning a detector in areas that may be difficult to access without a ladder, extension pole, or similar type of tool. Specifically, at least one embodiment of the invention provides a survey cart having a mobile platform and an adjustable-height mast. Accordingly, the survey cart facilitates the performance of a continuous and active wireless survey, thereby reducing equipment set-up time.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. An apparatus, comprising:
a platform;
at least one telescopic mast connected to said platform;
a boom connected to said telescopic mast;
a detector connected to said boom; and
a power supply connected to said detector.

2. The apparatus according to claim 1, wherein said detector comprises a wireless local area network (LAN) detector.

3. The apparatus according to claim 1, further comprising a dropped ceiling tee grid attached to said detector and said boom.

4. The apparatus according to claim 1, further comprising at least one caster connected to said platform.

5. The apparatus according to claim 4, wherein said caster facilitates continuous movement of said detector to reduce set up time of said detector in multiple locations.

6. The apparatus according to claim 1, wherein said telescopic mast comprises a first segment and at least one additional segment.

7. The apparatus according to claim 1, wherein said telescopic mast adjusts a height of said detector relative to said platform.

8. An apparatus, comprising:
a platform;
a mast connected to said platform;
a boom connected to said mast;
a detector connected to said boom;
at least one additional mast connected to said platform;
at least one additional boom connected to said additional mast;
at least one additional detector connected to said additional boom; and
a power supply connected to said detector and said additional detector.

9. The apparatus according to claim 8, wherein at least one of said mast, said additional mast, said boom, and said additional boom is telescopic.

10. The apparatus according to claim 8, wherein at least one of said detector and said additional detector comprises a wireless local area network (LAN) detector.

11. The apparatus according to claim 8, further comprising a dropped ceiling tee grid attached to said detector and said boom.

12. The apparatus according to claim 8, further comprising at least one caster connected to said platform, wherein said caster facilitates continuous movement of said detector to reduce set up time of said detector in multiple locations.

13. The apparatus according to claim 9, wherein said mast comprises a first segment and at least one additional segment.

14. The apparatus according to claim 9, wherein said mast adjusts a height of said detector relative to said platform.

15. An apparatus, comprising:
a platform;
at least one telescopic mast connected to said platform;
a wireless local area network (LAN) detector connected to said telescopic mast; and
a power supply connected to said LAN detector.

16. The apparatus according to claim 15, further comprising a boom connected to said telescopic mast and said LAN detector.

17. The apparatus according to claim 16, further comprising a dropped ceiling tee grid connected to said LAN detector and said boom.

18. The apparatus according to claim 16, further comprising:
at least one additional mast connected to said platform;
at least one additional boom connected to said additional mast; and
at least one additional detector connected to said additional boom.

19. The apparatus according to claim 15, further comprising at least one caster connected to said platform, wherein said caster facilitates continuous movement of said LAN detector to reduce set up time of said LAN detector in multiple locations.

20. The apparatus according to claim 15, wherein said telescopic mast comprises a first segment and at least one additional segment, and wherein said telescopic mast adjusts a height of said LAN detector relative to said platform.

21. A method of manufacturing an apparatus, wherein said method comprises:
forming a platform;
forming at least one telescopic mast connected to said platform;
forming a boom connected to said telescopic mast;
forming a detector connected to said boom; and
forming a power supply connected to said detector.

22. The method according to claim 21, wherein said forming of said detector comprises forming a wireless local area network (LAN) detector.

23. The method according to claim 21, further comprising forming a dropped ceiling tee grid attached to said detector and said boom.

24. The method according to claim 21, further comprising forming at least one caster connected to said platform, such that said caster facilitates continuous movement of said detector to reduce set up time of said detector in multiple locations.

25. The method according to claim 21, wherein said forming of said telescopic mast comprises forming a first segment and at least one additional segment, wherein said telescopic mast adjusts a height of said detector relative to said platform.
